(19) United States
(12) Patent Application Publication
(10) Pub. No.: US 2009/0308463 A1
(43) Pub. Date: Dec. 17, 2009

(54) BOTTLE TRAP WITH INTEGRAL GAS SEAL

(75) Inventors: MICHAEL David BACON, Boynton Beach, FL (US); Juan Manual Plasencia, Charlotte, NC (US); Ariel Temprana, Hialeah Gardens, FL (US); Yunus Topcan, Deerfield Beach, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(73) Assignee: Robert H. Mayer, Deerfield Beach, FL (US)

(21) Appl. No.: 12/466,613

(22) Filed: May 15, 2009

Related U.S. Application Data
(60) Provisional application No. 61/053,905, filed on May 16, 2008.

(51) Int. Cl. F16K 13/00

(52) U.S. Cl. 137/247

(57) ABSTRACT

Embodiments of the present invention address deficiencies of the art in respect to bottle traps and provide a bottle trap with an integral gas seal. In an embodiment of the invention, a bottle trap can include a body with both an inlet at a top portion of the body adapted to receive a tailpiece from a sink, and an outlet at a side portion of the body adapted to receive a horizontal drain pipe. The bottle trap further can include an integral metallic gas seal disposed within the body and defining two chambers of the body. The integral metallic gas seal can include a metallic wall being rigidly and non-removably coupled to an interior portion of the body at one end of the metallic wall and having an unattached distal end opposite to the top portion of the interior wall so as to permit passage of fluid from one of the chambers to another of the chambers. Optionally, the unattached distal end of the metallic wall can include a rounded tip.

### CROSS-REFERENCE TO RELATED APPLICATIONS

This patent application claims the benefit under 35 U.S.C. § 120 to presently pending U.S. Provisional Patent Application 61/053,905, filed on May 16, 2008 entitled BOTTLE TRAP WITH INTEGRAL GAS SEAL, the entire teachings of which are incorporated herein by reference.

### BACKGROUND OF THE INVENTION

1. Field of the Invention

The present invention relates to the field of drainage systems and sink traps and more particular to bottle traps.

2. Description of the Related Art

Bottle traps have typically been designed to improve the aesthetic appearance of a drain assembly while complying with local building codes related to the functionality and installation of drains. Existing traditional sink traps, installed, as required by building code, serve one main function—by means of a watertight seal sink traps isolate the municipal sewer system or localized septic system from the sink drain, thereby preventing sewer gases or septic gases and sewage from escaping into the indoor atmosphere through the skin drain. Traditionally, drainage systems incorporating a bottle trap are attached to the bottom of a lavatory basin by means of a tailpiece that extends down from the underside of the basin. Thereafter, waste liquids pass through the tailpiece, into the bottle trap, and exit the bottle trap through a horizontal pipe leading to the sewer system or septic tank.

A primary benefit of a bottle trap includes its ability to prevent harmful and noxious gasses from seeping into the dwelling space from the sewer system. To achieve this buffer, the bottle trap incorporates a “U”-shaped profile in an internal cavity of the bottle trap. In the past, this U-shaped profile has been achieved through the insertion of a plastic sleeve or liner into the main body of the bottle trap to split the internal cavity into two connected chambers through which waste water could flow. In consequence, waste water flows down from the sink basin, through the “U”-shaped profile in the bottle trap, and then upwards toward a horizontal leg on an outlet side of the bottle trap.

In illustration, with reference to FIG. 1, a conventional bottle trap 100 can include a body 110 with a separate plastic liner or insert 120 forming a U-shaped profile. The conventional bottle trap 100 also can include an inlet 150 and an outlet 160. The inlet 150 can be adapted to receive a tail piece 130 deeply into the plastic liner or insert 120 to support the U-shaped profile. Conversely, the outlet 160 can be adapted to receive a horizontal pipe 140.

In operation, the outlet 160, being higher in elevation than the “U”-shaped profile in the bottle trap 100, forces a small column of standing waste water to remain behind, thus creating a gas seal. As such, the “U”-shaped column of the standing waste water prevents those gasses from traveling from the sewer or septic tank through the drainage system into the dwelling space due to the specific gravity and the density of the water in the bottle trap 100. Accordingly, the gasses will have become “trapped”. Thus, it is elemental that a proper installation of a bottle trap 100 is required to achieve its intended effect. Any deviation that compromises the gas seal formed by the plastic sleeve or liner 120 will defeat the operation of the bottle trap 100.

Experience in the field indicates that oftentimes, the gas seal of the bottle trap will become compromised in direct consequence of an improper installation. Specifically, during the installation process, it is not uncommon for the installer to fail to apply the plastic liner or insert, or for the installer to break or otherwise remove the plastic liner or insert. Further, oftentimes both the horizontal leg and the tailpiece are misaligned when coupled to the bottle trap, or simply not completely joined to the bottle trap resulting in leakage.

### BRIEF SUMMARY OF THE INVENTION

Embodiments of the present invention address deficiencies of the art in respect to bottle traps and provide a novel and non-obvious bottle trap with an integral gas seal. In an embodiment of the invention, a bottle trap can include a body with both an inlet at a top portion of the body adapted to receive a tailpiece from a sink, and an outlet at a side portion of the body adapted to receive a horizontal drain pipe. The bottle trap further can include an integrated metallic gas seal disposed within the body and defining two chambers of the body. The integrated metallic gas seal can include a metallic wall being rigidly and non-removably coupled to an interior portion of the body at one end of the metallic wall and having an unattached distal end opposite to the top portion of the interior wall so as to permit passage of fluid from one of the chambers to another of the chambers. Optionally, the unattached distal end of the metallic wall can include a rounded tip.

In one aspect of the embodiment, the metallic wall is welded to the interior portion of the body. In another aspect of the embodiment, the metallic wall is molded as part of the interior portion of the body. In yet another aspect of the embodiment, the metallic wall is formed of brass. In even yet another aspect of the embodiment, the metallic wall is formed of a same material as the body.

Of note, the bottle trap also can include a mechanical stop abutting the inlet to provide tactile feedback indicating a complete insertion of a tail piece into the inlet. Similarly, the bottle trap can include a mechanical stop abutting the outlet to provide tactile feedback indicating a complete insertion of a horizontal pipe into the outlet.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a side cut-away view of a bottle trap with plastic insert known in the art;

FIG. 2 is a perspective view of a bottle trap which has been configured in accordance with an embodiment of the inventive arrangements;

FIG. 3 is a top view of the bottle trap of FIG. 2;

FIG. 4 is a side cut-away view of the bottle trap of FIG. 2; and,

FIG. 5 is an exploded view of a junction of a horizontal leg coupled to an end cap for the bottle trap of FIG. 4.

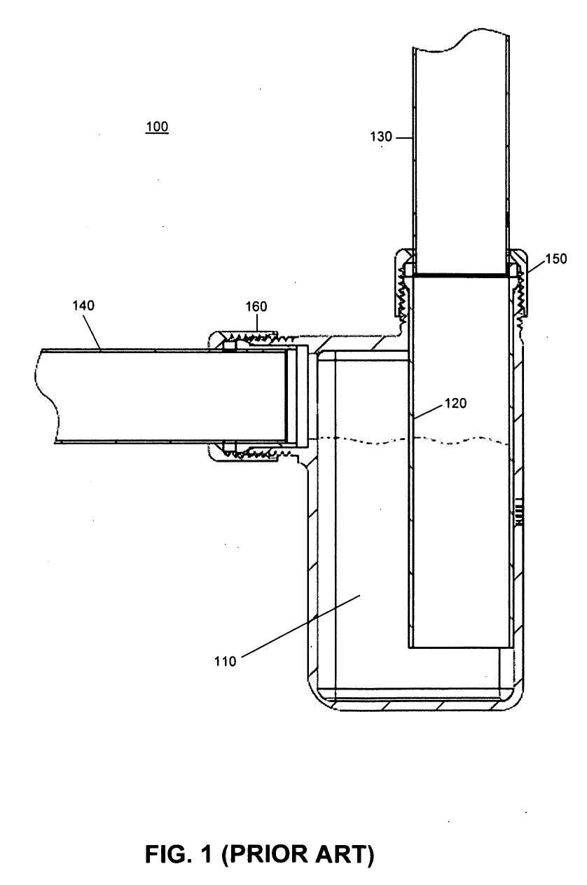

### DETAILED DESCRIPTION OF THE INVENTION

Embodiments of the present invention provide a bottle trap with integral gas seal. In accordance with an embodiment of the present invention, a bottle trap can include a body with integrated gas seal, an inlet adapted to receive a tailpiece and an outlet adapted to receive a horizontal pipe. The integrated gas seal can be of the same material as the body, for example brass and can be welded to the body to form a unitary whole. Further, the integrated gas seal can include a rounded tip to provide reduced pressure deviance in the flow of fluid about the tip within the body of the bottle trap. Finally, a mechanical stop, for example a plastic end cap, can be provided for each of the inlet and outlet to provide tactile feedback when coupling either the tail piece or horizontal pipe to the inlet or outlet, respectively.

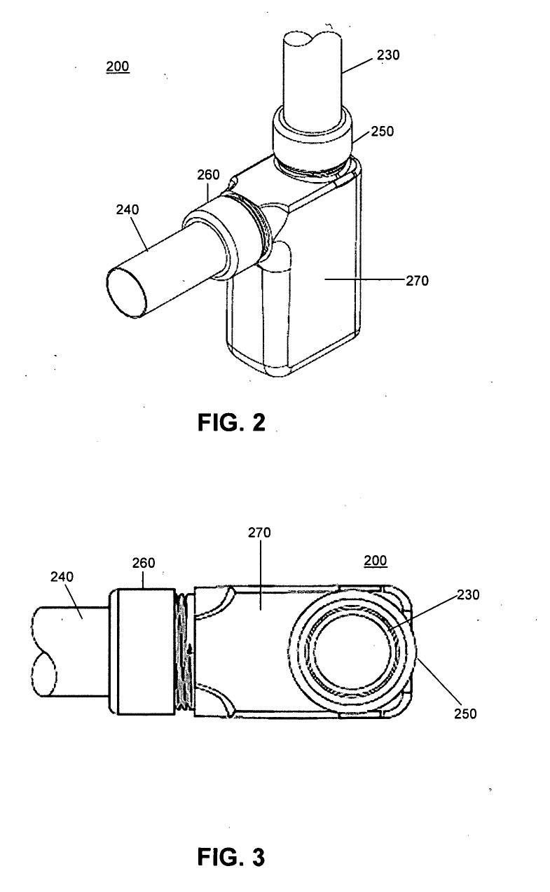

FIG. 2 is a perspective view of a bottle trap which has been configured in accordance with an embodiment of the inventive arrangements. The bottle trap 200 can include a body 270 with both an inlet 250 adapted to receive a tail piece 230, and also an outlet 260 adapted to receive a horizontal pipe 240. With reference to FIG. 3 showing a top view of the bottle trap of FIG. 2, again the bottle trap 200 can include a body 270 with both an inlet 250 adapted to receive a tail piece 230, and also an outlet 260 adapted to receive a horizontal pipe 240.

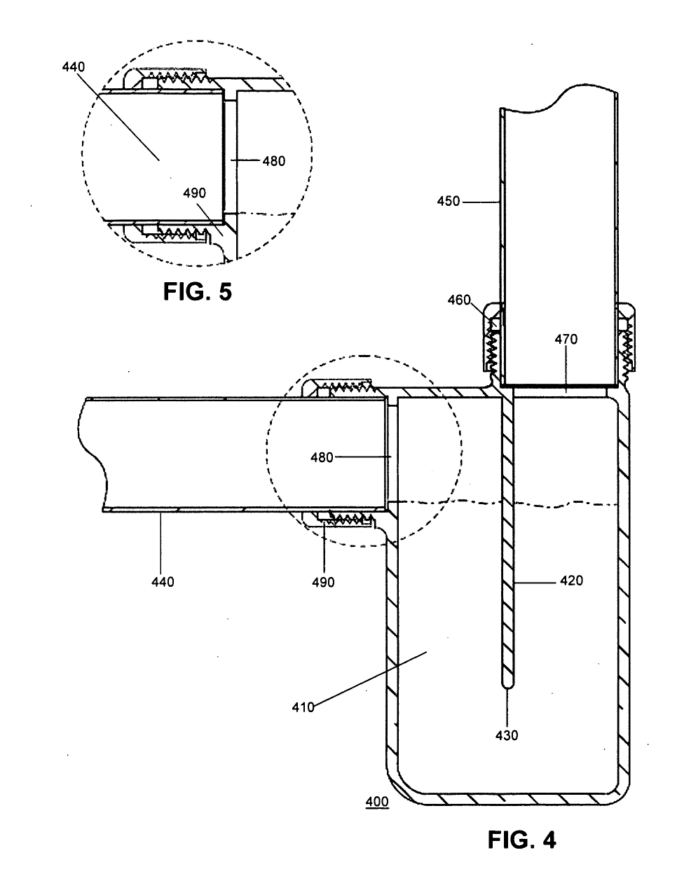

Turning now to FIG. 4, a side cut-away view of an embodiment of the bottle trap of FIG. 2 is shown. The bottle trap 400 of FIG. 4 can include a body 410 formed with an integral gas seal 420 as a unitary component. In this regard, the gas seal 420 can be of the same material as the body 410, for instance brass, and can be welded thereto or molded as a single piece. The integrated gas seal 420 can bifurcate a chamber defined by the body 410 into two substantially equal volumes and a distal tip of the integrated gas seal 420 can be rounded to facilitate fluid flow about a U-shaped profiled formed by the integrated gas seal 420.

Notably, an inlet 460 can be provided at a top portion of the body 410 and the inlet 460 can be adapted to receive a tail piece 450, for example by way of a threaded portion. However, a mechanical stop 470 also can be provided to abut the top of the body 410 to provide tactile feedback to an installer inserting the tail piece 450 into the inlet 460 so that the installer knows when the tail piece 450 can be inserted fully and further to ensure proper alignment with the body 410. Comparably, an outlet 490 can be provided at a side portion of the body 410 and the outlet 490 can be adapted to receive a horizontal pipe 440, for example by way of a threaded portion. As shown in FIG. 5, however, a mechanical stop 480 also can be provided to abut the side of the body 410 to provide tactile feedback to an installer inserting the horizontal pipe 44 into the outlet 490 so that the installer knows when the horizontal pipe 450 can be inserted fully and further to ensure proper alignment with the body 410.

The following unique design features have been included into a decorative bottle trap in order to render the bottle trap more functional and safer than any other known in the art:
By replacing the sleeve/liner with an integral wall that is molded directly into the decorative bottle trap cavity, a design was created that cannot be made nonfunctional, thereby eliminating the risk of potentially dangerous and noxious sewer gasses entering the dwelling space. Also, the absence of a sleeve/liner completely eliminates the risk of having the component fail during its lifetime due to material degradation, fractures or cracks, or omission of this component altogether from the installation.
Incorporating an internal wall within the bottle trap mold has allowed the elimination of the sleeve/liner altogether. This has two distinct advantages over prior designs. First, the removal of a sleeve/liner from the liquid waste channel assures a smooth, uninterrupted path, and thusly promotes a rapid discharge of waste liquids from the drainage system. No pressure increase is created inside the liquid waste channel due to obstructions in the walls of the channel created by the sleeve/liner.
Removal of this sleeve/liner also allows the “U”-shaped portion of the liquid waste channel to be re-profiled to increase the gas seal feature of the design, located at the bottom of this “U”-shaped channel. Prior designs were forced to depend on a long, straight sleeve/liner to create the required column of water, called the gas seal. This new increased water column (gas seal) further reinforces the safety functionality of this decorative bottle trap design.
By providing mechanical stops (walls) molded directly inside the inlet and outlet sides of the decorative bottle trap, the installer is provided with the tactile feedback required to assure that the piping is installed to the correct depth inside the decorative bottle trap cavity. Piping is simply pushed into the inlet and outlet sides of the decorative bottle trap until they bottom out against these mechanical stops. The overall benefit of this design improvement is that a completely watertight system is assured, and assembly time is shortened because all guesswork and trial fitting of piping is eliminated during installation.
All internal walls that direct the flow of waste water and mechanical stops that aid in installation have also been engineered in such a way that they do not obstruct the flow of liquid waste from the system.

We claim:

1. A bottle trap comprising:
a body with both an inlet at a top portion of the body adapted to receive a tailpiece from a sink and an outlet at a side portion of the body adapted to receive a horizontal drain pipe; and,
an integral metallic gas seal disposed within the body and defining two chambers of the body, the integral metallic gas seal comprising a metallic wall being rigidly and non-removably coupled to an interior portion of the body at one end of the metallic wall and having an unattached distal end opposite to the top portion of the interior wall so as to permit passage of fluid from one of the chambers to another of the chambers, the integral gas seal and body forming a unitary whole.

2. The bottle trap of claim 1, wherein the metallic wall is welded to the interior portion of the body.

3. The bottle trap of claim 1, wherein the metallic wall is molded as part of the interior portion of the body.

4. The bottle trap of claim 1, wherein the metallic wall is formed of brass.

5. The bottle trap of claim 1, wherein the metallic wall is formed of a same material as the body.

6. The bottle trap of claim 1, wherein the chambers defined by the metallic wall are of substantially equal volume.

7. The bottle trap of claim 1, further comprising a mechanical stop abutting the inlet to provide tactile feedback indicating a complete insertion of a tail piece into the inlet.

8. The bottle trap of claim 1, further comprising a mechanical stop abutting the outlet to provide tactile feedback indicating a complete insertion of a horizontal pipe into the outlet.

9. The bottle trap of claim 1, wherein the unattached distal end of the metallic wall comprises a rounded tip.
